(19) United States
(12) Patent Application Publication
(10) Pub. No.: US 2020/0183632 A1
(43) Pub. Date: Jun. 11, 2020

(54) METHOD, DEVICE, AND SYSTEM FOR OBTAINING SENSOR DATA, AND COMPUTER READABLE STORAGE MEDIUM

(71) Applicant: ZTE CORPORATION, Shenzhen, Guangdong (CN)

(72) Inventor: Dongxiao ZHAO, Shenzhen, Guangdong (CN)

(21) Appl. No.: 16/628,528

(22) PCT Filed: Jul. 3, 2018
(86) PCT No.: PCT/CN2018/094257

§ 371 Date: Jan. 3, 2020

(30) Foreign Application Priority Data
Jul. 3, 2017 (CN) 201710532286.1

(51) Int. Cl. G06F 3/14; G06K 9/00

(52) U.S. Cl. CPC G06F 3/1423; G06K 9/00228

(57) ABSTRACT

A method, device, and system for obtaining sensor data, and a computer readable storage medium. The method includes: obtaining use states of a first display and a second display; judging whether a display currently used is in the same terminal as a sensor according to the use states; reporting sensed data acquired by the sensor under the condition that the display currently used is in the same terminal as the sensor; and calibrating and reporting the sensed data under the condition that the display currently used is not in the same terminal as the sensor.

### FIELD OF THE INVENTION

The present disclosure relates to the technical field of mobile terminals, in particular to a method, device, and system for obtaining sensor data, and a computer readable storage medium.

### BACKGROUND

With the development of mobile terminals, more and more dual-screen terminals emerge. The dual-screen terminal has two screens with a certain angle therebetween, which determines different gestures of the two screens. A user may require different sensor data when using one of the screens. But currently, the dual-screen terminals only include one set of sensors located on the motherboard. As a result, the measured data are all sensor data of the screen on the same side as the motherboard. Thus, this part of sensor data may be erroneous when the user uses the other screen.

### SUMMARY

In view of the above, an objective of the present disclosure is to provide a method, device, and system for obtaining sensor data, and a computer readable storage medium.

According to an aspect of the present disclosure, there is provided a method for obtaining sensor data, including: obtaining use states of a first display and a second display, wherein the first display and the second display are rotatably connected and are disposed on a first terminal and a second terminal, respectively; judging whether a display currently used is in the same terminal as a sensor according to the use states; reporting sensed data acquired by the sensor under the condition that the display currently used is in the same terminal as the sensor; and calibrating and reporting the sensed data under the condition that the display currently used is not in the same terminal as the sensor.

According to another aspect of the present disclosure, there is provided a device for obtaining sensor data, including: an obtaining module configured to obtain use states of a first display and a second display, wherein the first display and the second display are rotatably connected and are disposed on a first terminal and a second terminal, respectively; a judgment module configured to judge whether a display currently used is in the same terminal as a sensor according to the use states, and report sensed data acquired by the sensor under the condition that the display currently used is in the same terminal as the sensor; and a calibration module configured to calibrate and report the sensed data under the condition that the display currently used is not in the same terminal as the sensor.

According to yet another aspect of the present disclosure, there is provided a system for obtaining sensor data, including: a memory, a processor, and at least one application stored in the memory and configured to be executed by the processor, wherein the application is configured to implement the method for obtaining sensor data as describe above.

According to still another aspect of the present disclosure, there is provided a computer readable storage medium having a computer program stored thereon which, when executed by a processor, implements the method for obtaining sensor data as described above.

### BRIEF DESCRIPTION OF THE DRAWINGS

FIG. 1 is a flowchart of a method for obtaining sensor data according to an embodiment of the present disclosure;

FIG. 2 is a schematic structural diagram of a dual-screen mobile terminal according to an embodiment of the present disclosure;

FIG. 3 is a schematic diagram of a rotation shaft angle sensor according to an embodiment of the present disclosure;

FIG. 4 is a flowchart of step S10 in FIG. 1;

FIG. 5 is a schematic state diagram of a first display and a second display according to an embodiment of the present disclosure;

FIG. 6 is a schematic state diagram of a first display and a second display according to an embodiment of the present disclosure;

FIG. 7 is a schematic state diagram of a first display and a second display according to an embodiment of the present disclosure;

FIG. 8 is a block diagram illustrating an exemplary structure of a device for obtaining sensor data according to an embodiment of the disclosure; and

FIG. 9 is a block diagram illustrating an exemplary structure of the obtaining module in FIG. 8.

The implementation of the objectives, functional features and advantages of the present disclosure will be further explained below with reference to the accompanying drawings and embodiments.

### DETAILED DESCRIPTION OF THE EMBODIMENTS

For clarity and better understanding of the technical problems, technical solutions and beneficial effects of the present disclosure, the present disclosure will be further described in detail below in conjunction with the accompanying drawings and embodiments. It will be appreciated that the specific embodiments described herein are merely for illustration of the disclosure and are not intended to limit the disclosure.

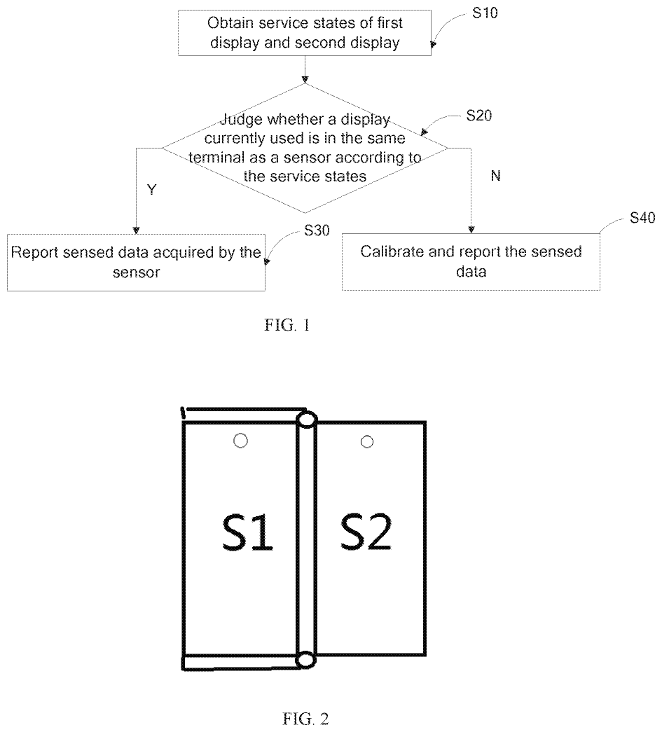

FIG. 1 is a flowchart of a method for obtaining sensor data according to an embodiment of the present disclosure. As shown in FIG. 1, in this embodiment, the method for obtaining sensor data includes the following steps.

At step S10, use states of a first display and a second display are obtained.

At step S20, it is judged whether a display currently used is in the same terminal as a sensor according to the use states.

At step S30, sensed data acquired by the sensor is reported under the condition that the display currently used is in the same terminal as the sensor.

And at step S40, the sensed data is calibrated and reported under the condition that the display currently used is not in the same terminal as the sensor.

In this embodiment, the screen currently used may be determined by a camera. The sensor data are calibrated if the display currently used and the sensor are located in different terminals. Therefore, the sensor data of the two screens can be obtained by using only one set of sensors. In such a manner, it is possible to improve the accuracy of sensor data while ensuring weight of the mobile terminal.

FIG. 2 is a schematic structural diagram of a dual-screen mobile terminal according to an embodiment of the present disclosure. As shown in FIG. 2, in this embodiment, the mobile terminal is a dual-screen mobile terminal including a first terminal and a second terminal connected through a rotation shaft, the first terminal is provided with a sensor, a first display S1 and a first camera; and the second terminal is provided with a second display S2 and a second camera. On the rotation shaft is provided an angle sensor connected to a CPU and configured to transmit data to the CPU. The first display S1 is located on the same side as the motherboard. The motherboard is provided with sensors such as a gravity sensor. In the method for obtaining sensor data according to this embodiment, the sensed data of the gravity sensor can be calibrated.

As another embodiment, the mobile terminal may be a multi-screen mobile terminal (having two or more display screens). In this case, the method for obtaining sensor data of the present disclosure is also applicable.

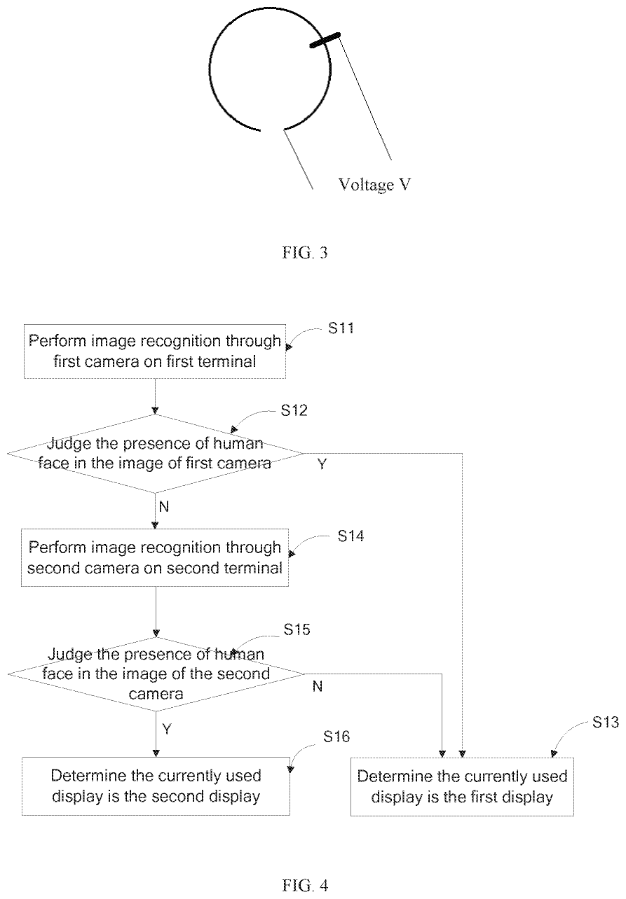

FIG. 3 is a schematic diagram of a rotation shaft angle sensor according to an embodiment of the present disclosure. As shown in FIG. 3, a ring resistor is provided at the rotation shaft, and a brush rotatable with the rotation shaft is mounted on the ring resistor. A voltage V is applied at one end of the ring resistor and the brush, and a resistance value A of the energized part can be determined by measuring a current I. The resistance value A may be used for obtaining a current rotation angle T, T=(A−M)*N, and M and N are constants representing characteristics of the current sensor.

As shown in FIG. 4, in this embodiment, the step S10 of obtaining use states of the first display and the second display includes the following steps.

At step S11, image recognition is performed through a first camera on the first terminal.

At step S12, it is judged whether a human face is present in the image of the first camera.

At step S13, it is determined that the display currently used is the first display under the condition that the human face is present in the image of the first camera.

At step S14, image recognition is performed through a second camera on the second terminal under the condition that no human face is present in the image of the first camera.

At step S15, it is judged whether a human face is present in the image of the second camera.

At step S16, it is determined that the display currently used is the second display under the condition that the human face is present in the image of the second camera.

And at step S13, it is determined that the display currently used is the first display under the condition that no human face is present in the image of the second camera.

In this embodiment, the first camera and the second camera are both connected to the CPU via a bus. Before the step S11, it is ensured that data in the Z-axis direction of the gravity sensor is greater than 0. That is, the step of obtaining use states of the first display and the second display is performed only when a user picks up the mobile terminal.

In this embodiment, the step of calibrating and reporting the sensed data may include the following steps.

An angle T between the first display and the second display is obtained, and sensed data X, Y and Z of the sensor on x-axis, y-axis, and z-axis are obtained, respectively. X, Y and Z represents the sensed data in directions of the x-axis, the y-axis, and the z-axis in a coordinate system, respectively.

When the first display and the second display are arranged side by side so that the angle T is 180 degrees, the obtained sensed data after calibration are X, Y and Z.

When the first display and the second display are arranged in a back-to-back manner so that the angle T is 0 degree, the sensed data after calibration are X, Y and −Z.

When the rotation shaft is parallel to the horizontal plane and a V-shaped opening formed by the first display and the second display faces downwards so that the angle T satisfies 0<T<180 and |Y|<U1, the states of the first display and the second display are as shown in FIG. 5, and the sensed data after calibration are −X, Y and Z. Herein U1 is a first threshold value.

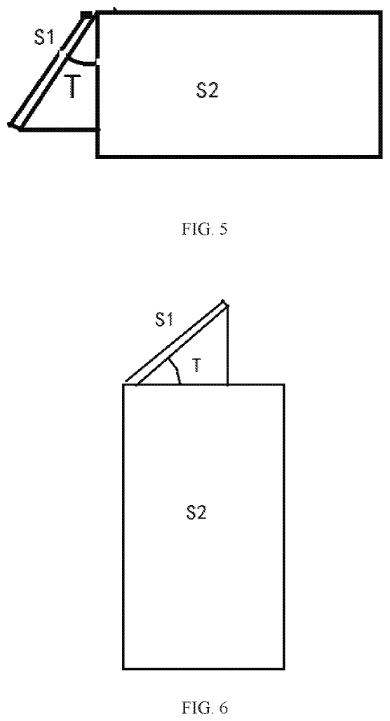

When the rotation shaft is perpendicular to the horizontal plane so that the angle T satisfies 0<T<180 and ∥Y|−10|<U2, the states of the first display and the second display are as shown in FIG. 6, and the sensed data after calibration are X, Y and Z. Herein U2 is a second threshold value.

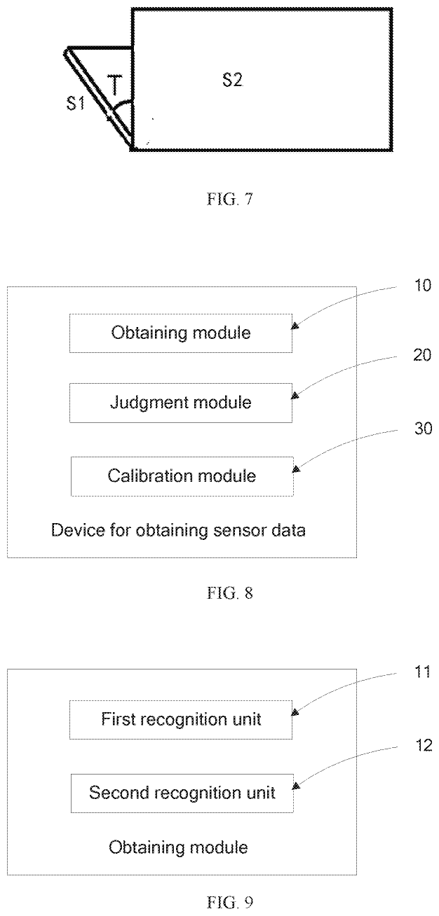

When the rotation shaft is parallel to the horizontal plane and the V-shaped opening formed by the first display and the second display faces upwards so that the angle T satisfies 0<T<180 and |Y|<U3, |Z−10|<U4, the states of the first display and the second display are as shown in FIG. 7, and the sensed data after calibration are X1, Y1 and Z1. Herein U3 is a third threshold value, and U4 is a fourth threshold value.

Y1=Y,

tan(T)=X1/Z1, and

(X1)\hat{ }2+(Y1)\hat{ }2+(Z1)\hat{ }2=(X)\hat{ }2+(Y)\hat{ }2+(Z)\hat{ }2.

The sensed data after calibration is reported.

In this embodiment, U1, U2, U3 and U4 are preset values close to 0.

FIG. 8 is a block diagram illustrating an exemplary structure of a device for obtaining sensor data according to an embodiment of the disclosure. As shown in FIG. 8, in this embodiment, a device for obtaining sensor data includes: an obtaining module 10, a judgment module 20 and a calibration module 30.

The obtaining module 10 is configured to obtain use states of a first display and a second display.

The judgment module 20 is configured to judge whether a display currently used is in the same terminal as a sensor according to the use states, and report sensed data acquired by the sensor under the condition that the display currently used is in the same terminal as the sensor.

The calibration module 30 is configured to calibrate and report the sensed data under the condition that the display currently used is not in the same terminal as the sensor.

In this embodiment, a display currently used may be determined through a camera. The sensor data are calibrated if the display currently used and the sensor are located in different terminals. Therefore, the sensor data of the two screens can be obtained by using only one set of sensors. In such a manner, it is possible to improve the accuracy of sensor data while ensuring weight of the mobile terminal.

FIG. 2 is a schematic structural diagram of a dual-screen mobile terminal according to an embodiment of the present disclosure. As shown in FIG. 2, in this embodiment, the mobile terminal is a dual-screen mobile terminal including a first terminal and a second terminal connected through a rotation shaft. Herein, the first terminal is provided with a sensor, and a first display S1 and a first camera; and the second terminal is provided with a second display S2 and a second camera. On the rotation shaft is provided an angle sensor connected to a CPU and configured to transmit data to the CPU. The first display S1 is located on the same side as the motherboard. The motherboard is provided with sensors such as a gravity sensor. In the method for obtaining sensor data according to this embodiment, the sensed data of the gravity sensor can be calibrated.

As another embodiment, the mobile terminal may be a multi-screen mobile terminal (having two or more display screens). In this case, the method for obtaining sensor data of the present disclosure is also applicable.

FIG. 3 is a schematic diagram of a rotation shaft angle sensor according to an embodiment of the present disclosure. As shown in FIG. 3, a ring resistor is provided at the rotation shaft, and a brush rotatable with the rotation shaft is mounted on the ring resistor. A voltage V is applied at one end of the ring resistor and the brush, and a resistance value A of the energized part can be determined by measuring a current I. The resistance value A may be used for obtaining a current rotation angle T, T=(A−M)*N. Herein M and N are constants representing characteristics of the current sensor.

As shown in FIG. 9, in this embodiment, the obtaining module includes: a first recognition unit 11 and a second recognition unit 12.

The first recognition unit 11 configured to perform image recognition through a first camera on the first terminal, and judge whether a human face is present in the image of the first camera. Herein it is determined that the display currently used is the first display under the condition that the human face is present in the image of the first camera.

The second recognition unit 12 configured to perform image recognition through a second camera on the second terminal under the condition that no human face is present in the image of the first camera, and judge whether a human face is present in the image of the second camera. It is determined that the display currently used is the second display under the condition that the human face is present in the image of the second camera, and it is determined that the display currently used is the first display under the condition that no human face is present in the image of the second camera.

In this embodiment, the calibration module 30 is further configured to: obtain an angle T between the first display and the second display, and obtain sensed data X, Y and Z of the sensor on x-axis, y-axis, and z-axis, respectively, and report the sensed data after calibration.

Herein X, Y, Z represents the sensed data in directions of the x-axis, the y-axis, and the z-axis in a coordinate system, respectively.

When the first display and the second display are arranged side by side so that the angle T is 180 degrees, the sensed data after calibration are X, Y and Z.

When the first display and the second display are arranged in a back-to-back manner so that the angle T is 0 degree, the sensed data after calibration are X, Y and −Z.

When the rotation shaft is parallel to the horizontal plane and a V-shaped opening formed by the first display and the second display faces downwards so that the angle T satisfies 0<T<180 and |Y|<U1, the states of the first display and the second display are as shown in FIG. 5, and the sensed data after calibration are −X, Y and Z. Herein U1 is a first threshold value.

When the rotation shaft is perpendicular to the horizontal plane so that the angle T satisfies 0<T<180 and ∥Y|−10|<U2, the states of the first display and the second display are as shown in FIG. 6, and the sensed data after calibration are X, Y and Z. Herein U2 is a second threshold value.

When the rotation shaft is parallel to the horizontal plane and the V-shaped opening formed by the first display and the second display faces upwards so that the angle T satisfies 0<T<180 and |Y|<U3, |Z−10|<U4, the states of the first display and the second display are as shown in FIG. 7, and the sensed data after calibration are X1, Y1 and Z1. Herein U3 is a third threshold value, and U4 is a fourth threshold value,

Y1=Y,

tan(T)=X1/Z1, and

(X1)\hat{ }2+(Y1)\hat{ }2+(Z1)\hat{ }2=(X)\hat{ }2+(Y)\hat{ }2+(Z)\hat{ }2; and

[symbol]

In this embodiment, U1, U2, U3 and U4 are preset values close to 0.

In an embodiment of the present disclosure, there is further provided a system for obtaining sensor data, including: a memory, a processor, and at least one application stored in the memory and configured to be executed by the processor, wherein the application is configured to implement the method for obtaining sensor data as describe in the embodiment.

In an embodiment of the present disclosure, there is further provided a computer readable storage medium storing a computer program thereon which, when executed by a processor, implements any one of the embodiments of the method for obtaining sensor data as described above.

It should be noted that the embodiments of the above device, system, and computer readable storage medium belong to the same concept as the method embodiments, and the specific implementation process thereof is described in detail in the method embodiments. Moreover, the technical features in the method embodiments are correspondingly applicable in the device embodiments, and detailed descriptions of the embodiments of the device, the system and the computer readable storage medium are omitted herein.

The embodiments of the disclosure provide a method, device, and system for obtaining sensor data, and a computer readable storage medium. The method includes: obtaining use states of a first display and a second display; judging whether a display currently used is in the same terminal as a sensor according to the use states; reporting sensed data acquired by the sensor under the condition that the display currently used is in the same terminal as the sensor; and calibrating and reporting the sensed data under the condition that the display currently used is not in the same terminal as the sensor. The method further includes: determining a display currently used through a camera; and calibrating sensor data in case that the display currently used and the sensor are located in different terminals. Therefore, the sensor data of the two screens can be obtained by using only one set of sensors. In such a manner, it is possible to improve the accuracy of sensor data while ensuring weight of the mobile terminal.

Through the description of the above embodiments, those skilled in the art can clearly understand that the method according to the above embodiment may be implemented by means of software plus a necessary general hardware platform. Obviously, it may also be implemented by hardware, but in most cases, the former is preferable. Based on such understanding, the technical solutions of the present invention essentially or, in other words, a part thereof contributing to the prior art, can be embodied in a form of a software product, wherein the software product is stored in a storage medium (such as an ROM/RAM, a disk, or an optical disc) and includes a number of instructions to cause a terminal device (which may be a mobile phone, a computer, a server, an air conditioner or a network device, etc.) to execute the methods of the various embodiments of the present disclosure.

The preferred embodiments of the present disclosure have been described above with reference to the accompanying drawings, but the scope of the present disclosure is not limited thereby. Any modifications, equivalent substitutions, and improvements made by those skilled in the art without departing from the scope and spirit of the present disclosure are intended to be within the scope of the claims of the present disclosure.

1. A method for obtaining sensor data, comprising:
obtaining use states of a first display and a second display, wherein the first display and the second display are rotatably connected and are disposed on a first terminal and a second terminal respectively;
judging whether a display currently used is in the same terminal as a sensor according to the use states;
reporting sensed data acquired by the sensor under the condition that the display currently used is in the same terminal as the sensor; and
calibrating and reporting the sensed data under the condition that the display currently used is not in the same terminal as the sensor.

2. The method for obtaining sensor data according to claim 1, wherein the step of obtaining use states of the first display and the second display comprises:
performing image recognition through a first camera on the first terminal;
judging whether a human face is present in the image of the first camera;
determining that the display currently used is the first display under the condition that the human face is present in the image of the first camera;
performing image recognition through a second camera on the second terminal under the condition that no human face is present in the image of the first camera;
judging whether a human face is present in the image of the second camera;
determining that the display currently used is the second display under the condition that the human face is present in the image of the second camera; and
determining that the display currently used is the first display under the condition that no human face is present in the image of the second camera.

3. The method for obtaining sensor data according to claim 2, wherein the step of calibrating and reporting the sensed data comprises:
obtaining an angle T between the first display and the second display, and obtaining sensed data X, Y and Z of the sensor on x-axis, y-axis, and z-axis, respectively, wherein X, Y and Z represents the sensed data in directions of the x-axis, the y-axis, and the z-axis in a coordinate system, respectively, wherein
when the first display and the second display are arranged side by side so that the angle T is 180 degrees, the obtained sensed data after calibration are X, Y and Z, and
when the first display and the second display are arranged in a back-to-back manner so that the angle T is 0 degree, the sensed data after calibration are X, Y and −Z.

4. The method for obtaining sensor data according to claim 3, wherein the step of calibrating and reporting the sensed data further comprises:
obtaining a state of a rotation shaft between the first display and the second display, the state of the rotation shaft comprising a state parallel to a horizontal plane and a state perpendicular to the horizontal plane, wherein
when the rotation shaft is parallel to the horizontal plane and a V-shaped opening formed by the first display and the second display faces downwards so that the angle T satisfies 0<T<180 and |Y|<U1, the sensed data after calibration are −X, Y and Z, wherein U1 is a first threshold value,
when the rotation shaft is perpendicular to the horizontal plane so that the angle T satisfies 0<T<180 and ∥Y|−10|<U2, the sensed data after calibration are X, Y and Z, wherein U2 is a second threshold value, and
when the rotation shaft is parallel to the horizontal plane and the V-shaped opening formed by the first display and the second display faces upwards so that the angle T satisfies 0<T<180 and |Y|<U3, |Z−10|<U4, the sensed data after calibration are X1, Y1 and Z1, wherein U3 is a third threshold value, U4 is a fourth threshold value,
Y1=Y,
tan(T)=X1/Z1, and
(X1)\hat{ }2+(Y1)\hat{ }2+(Z1)\hat{ }2=(X)\hat{ }2+(Y)\hat{ }2+(Z)\hat{ }2; and
reporting the sensed data after calibration.

5. A device for obtaining sensor data, comprising:
an obtaining module configured to obtain use states of a first display and a second display, wherein the first display and the second display are rotatably connected and are disposed on a first terminal and a second terminal, respectively;
a judgment module configured to judge whether a display currently used is in the same terminal as a sensor according to the use states, and report sensed data acquired by the sensor under the condition that the display currently used is in the same terminal as the sensor; and
a calibration module configured to calibrate and report the sensed data under the condition that the display currently used is not in the same terminal as the sensor.

6. The device for obtaining sensor data according to claim 5, wherein the obtaining module comprises:
a first recognition unit configured to perform image recognition through a first camera on the first terminal, and judge whether a human face is present in the image of the first camera, wherein it is determined that the display currently used is the first display under the condition that the human face is present in the image of the first camera; and
a second recognition unit configured to perform image recognition through a second camera on the second terminal under the condition that no human face is present in the image of the first camera, and judge whether a human face is present in the image of the second camera, wherein it is determined that the display currently used is the second display under the condition that the human face is present in the image of the second camera, and it is determined that the display currently used is the first display under the condition that no human face is present in the image of the second camera.

7. The device for obtaining sensor data according to claim 6, wherein the calibration module is further configured to:
obtain an angle T between the first display and the second display, and obtain sensed data X, Y and Z of the sensor on x-axis, y-axis, and z-axis, respectively, wherein X, Y, Z represents the sensed data in directions of the x-axis, the y-axis, and the z-axis in a coordinate system, respectively, wherein
when the first display and the second display are arranged side by side so that the angle T is 180 degrees, the sensed data after calibration are X, Y and Z, and
when the first display and the second display are arranged in a back-to-back manner so that the angle T is 0 degree, the sensed data after calibration are X, Y and −Z.

8. The device for obtaining sensor data according to claim 7, wherein the calibration module is further configured to:
obtain a state of a rotation shaft between the first display and the second display, the state of the rotation shaft comprising a state parallel to a horizontal plane and a state perpendicular to the horizontal plane, wherein
when the rotation shaft is parallel to the horizontal plane and a V-shaped opening formed by the first display and the second display faces downwards so that the angle T satisfies 0<T<180 and |Y|<U1, the sensed data after calibration are −X, Y and Z, wherein U1 is a first threshold value,
when the rotation shaft is perpendicular to the horizontal plane so that the angle T satisfies 0<T<180 and ∥Y|−10|<U2, the sensed data after calibration are X, Y and Z, wherein U2 is a second threshold value, and
when the rotation shaft is parallel to the horizontal plane and the V-shaped opening formed by the first display and the second display faces upwards so that the angle T satisfies 0<T<180 and |Y|<U3, |Z−10|<U4, the sensed data after calibration are X1, Y1 and Z1, wherein U3 is a third threshold value, U4 is a fourth threshold value,
Y1=Y,
tan(T)=X1/Z1, and
(X1)2+(Y1)2+(Z1)2=(X)2+(Y)2+(Z)2; and
report the sensed data after calibration.

9. A system for obtaining sensor data, comprising: a memory, a processor, and at least one application stored in the memory and configured to be executed by the processor, wherein the application is configured to implement the method for obtaining sensor data according to claim 1.

10. A computer readable storage medium having a computer program stored thereon which, when executed by a processor, implements the method for obtaining sensor data according to claim 1.

11. The method for obtaining sensor data according to claim 1, wherein the first terminal and the second terminal are connected through a rotation shaft and an angle sensor is provided on the rotation shaft.

12. The method for obtaining sensor data according to claim 11, wherein a ring resistor is provided at the rotation shaft, and a brush rotatable with the rotation shaft is mounted on the ring resistor.

13. The device for obtaining sensor data according to claim 5, wherein the first terminal and the second terminal are connected through a rotation shaft and an angle sensor is provided on the rotation shaft.

14. The device for obtaining sensor data according to claim 13, wherein a ring resistor is provided at the rotation shaft, and a brush rotatable with the rotation shaft is mounted on the ring resistor.
